(19) United States
(12) Patent Application Publication
(10) Pub. No.: US 2005/0039566 A1
(43) Pub. Date: Feb. 24, 2005

(54) Steering and production method therefor

(76) Inventors: Toru Makino, Inasa-gun (JP); Shigeru Kinpara, Hamamatsu-shi (JP); Takayoshi Inagaki, Hamamatsu-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/653,994

(22) Filed: Sep. 4, 2003

(30) Foreign Application Priority Data
Sep. 5, 2002 (JP) 2002-260020
Sep. 1, 2003 (JP) 2003-309063

(51) Int. Cl. B62D 1/04

(52) U.S. Cl. 74/552

(57) ABSTRACT

A steering has a surface material made of a ligneous material and an improved moisture resistance. The steering has a core and a surface material covering the core, and the core and the surface material are formed integrally. The surface material comprises a surface decorative material, a plurality of ligneous thin plates and adhesive sheets in which an adhesive resin having a moisture resistance is permeated in a base material, and the adhesive sheet is between the surface decorative material and the ligneous thin plate and is between the ligneous thin plates.

### BACKGROUND OF THE INVENTION

1. Field of the Invention

The present invention relates to a steering for a vehicle, in particular, a steering comprising a ligneous surface material, and to a production method therefor.

2. Description of the Related Art

In general, a steering for a vehicle comprises a core and a surface material covering the core.

A ligneous surface material used for the steering having this structure includes, for example, a laminated product in which a plurality of ligneous thin plates applied with an adhesive are laminated.

FIG. 7 is a cross-sectional view showing a conventional ligneous steering.

The steering 13 shown in FIG. 7 comprises mainly a core 14 which is a metal rod or a metal pipe and a surface material 15 covering the outer periphery of the core 14. The surface material 15 comprises a surface decorative material 16 which is a surface layer and a ligneous plywood layer 17 which is made by laminating ligneous thin plates and which is mounted to the inside of the surface decorative material 16. In the steering 13, the surface materials 15 and 15, which are separately prepared, are joined, and the joining portions 18 and 18 between the surface materials 15 and 15 are on the outer periphery of the core 14, the surface materials 15 and 15 are adhered to the outer periphery of the core 14 via an adhesive layer 19. That is, the surface material 15 is attached on the core 14, via the adhesive layer 19. In addition, a coating film 20 is applied to the outer periphery of the surface decorative material 16.

For example, the steering 13 is manufactured by the following processes. First, ligneous thin plates, which are applied with an adhesive, are laminated and adhered, and thereby the ligneous plywood layer 17 is prepared. After that, the ligneous plywood layer 17 is adhered to the surface decorative material 16, which is prepared in advance by pressing using a die while the ligneous plywood layer 17 and the surface decorative material are formed. Then, the end surfaces the formed product comprising the ligneous plywood layer 17 and the surface decorative material 16 are cut such that the end surfaces will be abutted and adhered, and thereby the surface material 15 having a semicircular cross section was prepared. That is, in order to abutt and adhere the formed product, the end surfaces which make the joining portions 18 and 18 are cut, and thereby the surface material 15 was prepared. The prepared surface materials 15 and 15 are arranged so as to cover the core 14. The joining portions 18 and 18 of the surface materials 15 and 15 are adhered, the surface materials 15 and 15 and the core 14 are adhered using the adhesive layer 19, and thereby the surface materials 15 and 15 and the core 14 are integrated. After that, the steering 13 is prepared by applying the coating film 20 on the surface of the surface materials 15 and 15.

As a steering having a such structure, for example, a steering comprising a ligneous sliced veneer as the surface decorative material is disclosed in Unexamined Japanese Patent Application, First Publication No. 2001-30915.

However, when the steering 13 is subjected to high humidity for a long time, because the adhesive used in the surface material 15 is thin and moisture permeates easily toward the interior of the surface material 15, in some cases, the moisture in causes the interior of the surface material 15 to swell and cracks are generated in the joining portion 18 between the surface materials 15 and 15, as shown in FIG. 8. As a result, a problem arises in that the coating film 20 is split along the joining portion 18 and crack 21 is generated in the steering 13.

### SUMMARY OF THE INVENTION

In consideration of the above-described problems, objects of the present invention are to provide a steering comprising a ligneous surface material and having an improved moisture resistance, and a production method therefor.

As a result of diligent research for achieving the object, the present inventors have demonstrated that the generation of cracks of the abutted and adhered portions of the steering can be prevented by using an adhesive sheet for adhering the surface decorative material and the ligneous thin plates, which is obtained by permeating an adhesive resin which has a moisture resistance in a base material.

That is, the present invention provides a steering comprising a core and a surface material covering the core, and the core and the surface material are integrated, wherein the surface material comprises a surface decorative material, a plurality of ligneous thin plates, and adhesive sheets for adhering between the surface decorative material and the ligneous thin plate and between the ligneous thin plates; and wherein the adhesive sheet comprises a base material in which an adhesive resin which has moisture resistance is permeated.

In addition, the present invention provides a production method for a steering comprising a core and a surface material covering the core, and the core and the surface material are integrated, the method comprising the steps of: laminating a surface decorative material and a plurality of ligneous thin plates via adhesive sheets in each of which an adhesive resin having a moisture resistance permeates in a base material; and adhering and forming the surface decorative material and a plurality of the ligneous thin plates in one process, and thereby the surface material is prepared.

In the steering and the production method therefor of the present invention, the adhesive sheet, which is obtained by permeating an adhesive resin having a moisture resistance in a base material, is used. When the steering is subjected to high humidity for a long time, moisture permeates into the ligneous material, such as the surface decorative material and the ligneous thin plate, and the moisture permeated in the ligneous material causes swelling. The adhesive resin having a moisture resistance can prevent such permeation of moisture. Thereby, the steering and the production method of the present invention can prevent the generation of cracks at the adhered portions of the surface materials.

It is preferable for the adhesive resin having a moisture resistance to be at least one thermosetting resin selected from melamine resins, phenol resins, diallyl phthalate resins, epoxy resins, urea melamine resins. urea reins, and urea melamine phenol resins.

### BRIEF DESCRIPTION OF THE DRAWINGS

FIG. 1 is a cross-sectional view showing a steering according to the present invention.

FIG. 2 is an enlarged view of the surface material which is an essential portion of the steering shown in FIG. 1.

FIG. 3 is a schematic view showing a form of a surface decorative material, ligneous thin plates, and adhesive sheets, which arc used in a production method for a steering according to the present invention.

FIG. 4 is a schematic cross-sectional view showing one process in a production method for a steering according to the present invention.

FIG. 5 is a schematic cross-sectional view showing a surface material obtained in a production method for a steering according to the present invention.

FIG. 6 is a schematic cross-sectional view showing surface materials and a core in a production method for a steering according to the present invention.

FIG. 7 is a planar view having a partial cross section showing a steering obtained in a production method for a steering according to the present invention.

FIG. 8 is a schematic view showing another steering obtained in a production method for a steering according to the present invention.

FIG. 9 is a cross-sectional view showing a conventional steering.

FIG. 10 is a cross-sectional view showing a problem in the conventional steering shown in FIG. 7.

### DETAILED DESCRIPTION OF THE INVENTION

Below, the present invention will be explained in detail with reference to figures. Moreover, the present invention is not limited to the following embodiments.

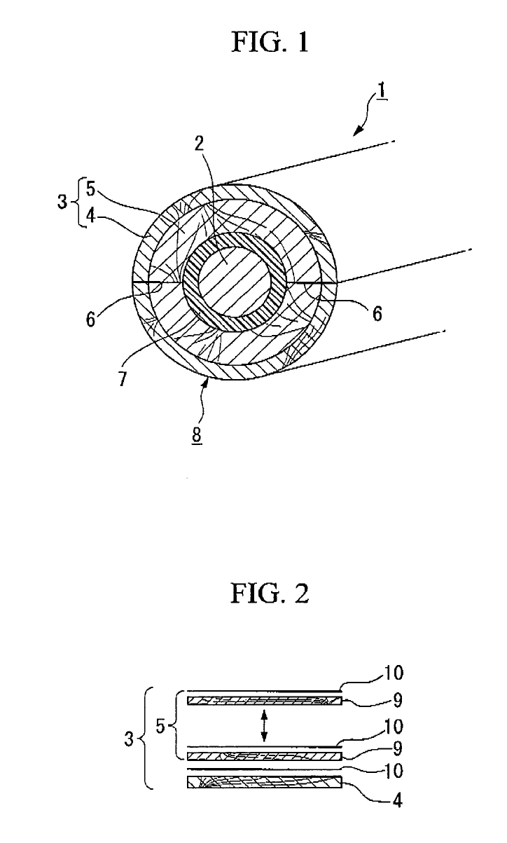

FIG. 1 is a cross-sectional view showing one embodiment of a steering according to the present invention. The steering 1 comprises mainly a core 2 and surface materials 3 and 3 which cover the outer periphery of the core 2. The surface material 3 comprises a surface decorative material 4 which is a surface layer and a ligneous plywood layer 5 which is mounted to the inside of the surface decorative material 4 and which comprises laminated ligneous thin plates.

In the steering 1, the surface materials 3 and 3, which are prepared separately, are abutted and joined. Joining portions 6 and 6 between the surface materials 3 and 3 are positioned on the outer periphery of the core 2 via an adhesive layer 7. That is, the surface materials 3 and 3 are attached to the core 2 via the adhesive layer 7. In addition, a coating film 8 is attached to the surface of the surface decorative material 4.

The core 2 is a metal rod or a metal pipe and may have any cross-sectional shape. The core 2 may be formed by die-casting a light metal such as aluminum or magnesium.

The surface material 3, as shown in FIG. 2, comprises the surface decorative material 4, the ligneous plywood layer 5, and an adhesive sheet 10. The ligneous plywood layer 5 is a laminated product in which a plurality of ligneous thin plates 9 are laminated via the adhesive sheet 10. The surface material 3 is prepared by laminating the surface decorative material 4 to the ligneous plywood layer 5, which comprises a plurality of the ligneous thin plates 9 and a plurality of the adhesive sheets 10, using the adhesive sheet 10, and combining integrally the surface decorative material 4, the ligneous plywood layer 5, and the adhesive sheet 10 while the surface decorative material 4, the ligneous plywood layer 5, and the adhesive sheet 10 are formed so as to curve. It is not necessary to attach the adhesive sheet 10 to the innermost part of the surface material 3. That is, it is possible to omit the adhesive sheet 10 of the surface material 3, which faces the core 2. However, when the surface material 3 comprises the adhesive sheet 10 facing the core 2, it is possible to provide the adhesive layer 7 partially on the core 2. That is, it not necessary to provide the adhesive layer 7 on the entirety of the surface of the core 2. Therefore, the surface material 3 preferably comprises the adhesive sheet 10 facing the core 2.

The surface decorative material 4 may be a decorative material, which comprises a ligneous veneer and a backing material attached to one side of the ligneous veneer, or a veneer/resin composite material, in which a ligneous veneer and a resin thin plate are laminated. The surface decorative material 4 is preferably a decorative material comprising a backing material. The thickness of the decorative material comprising a backing material is preferably in a range of 0.2 to 0.6 mm.

The backing material for the decorative material preferably includes a Japanese paper, and a nonwoven fabric made of chemical fibers. In particular, a nonwoven fabric is preferably used. A decorative material comprising a nonwoven fabric as a backing material has an improved strength. Therefore, when the decorative material comprising a nonwoven fabric as a backing material is used for the surface decorative material 4, breakage during the production processes can be prevented.

In addition, the surface of the surface decorative material 4 may be colored, coated, and have a film provided thereon in advance. Specifically, the surface of the surface decorative material 4 may be color-coated or color-painted with a water paint, a urethane coating, and the like. In addition, the surface of the surface decorative material 4, which is color-coated or color-painted, may be adhered to a clear film laminate. When the clear film laminate is adhered, heat resistance of the surface decorative material 4 is improved. The thickness of the clear film laminate is preferably in a range of 50 to 200 μm.

As explained above, in the ligneous plywood layer 5, the ligneous thin plates 9 are laminated via the adhesive sheets 10. The ligneous thin plate 9 includes, for example, a sliced veneer made of a natural wood such as walnut, birch, or ayus, and artificial sliced veneers. In particular, an artificial sliced veneer, which is obtained by laminating artificially a plurality of ligneous veneers and is sliced is preferably used for the ligneous thin plate 9. The artificial sliced veneer provides a uniform formability. The thickness of the ligneous thin plate 9 is preferably in a range of 0.2 to 1.0 mm.

The adhesive sheet 10 is prepared by permeating an adhesive resin having a moisture resistance in a base material. As the adhesive resin, at least one thermosetting resin having a high moisture resistance, such as melarnine resins, phenol resins, diallyl phthalate resins, epoxy resins, urea melamine resins, urea reins, and urea melamine phenol resins, is preferable. The amount of the adhesive resin is preferably in a range of 20 to 150 g/m², and more preferably in a range of 60 to 100 g/m², with respect to an area of the base material.

The base material of the adhesive sheet 10 includes, for example, a Japanese paper and a nonwoven fabric. In particular, a nonwoven fabric made of chemical fibers is preferable for the base material. The chemical fibers are preferably polyesters and nylons. When the adhesive sheet 10 comprises a nonwoven fabric which is made of polyesters or nylons, the thickness Suitable for preventing the moisture penetration is easily obtained In addition, this adhesive sheet 10 has an extensibility such that the adhesive sheet 10 is not split during the production processes.

The steering 1 having such a structure is, for example, prepared by the following processes.

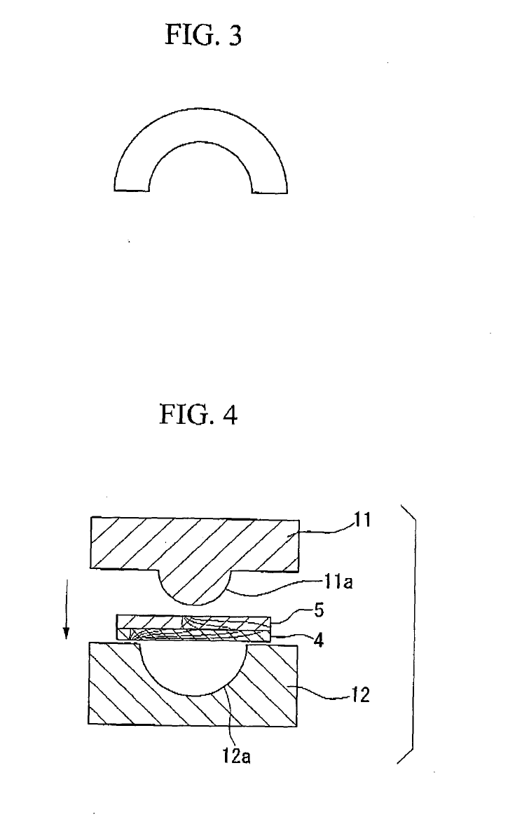

First, the surface decorative material 4, the ligneous thin plates 9 and the adhesive sheets 10 are cut so as to have a fall shape, as shown in FIG. 3.

Then, as shown in FIG. 2, one surface decorative material 4 and a plurality of the ligneous thin plates 9 are laminated such that the adhesive sheet 10 is sandwiched between the surface decorative material 4 and the ligneous thin plate 9, and between the ligneous thin plates 9 and 9.

In order to form the surface material 3 while integrating the surface decorative material 4, the ligneous thin plates 9, and the adhesive sheets 10, a forming die comprising an upper die 11 and a lower die 12, as shown in FIG. 4, is used. The lower die 12 comprises a cavity 12a having a shape which substantially conforms to the external shape of the steering 1. The upper die 11 comprises a protruding portion 11a on the lower surface thereof, which contacts the upper surface of the lower die 12. The protruding portion 11 a has a cross-section in a semi-circular shape which is smaller than the cross-section of the cavity 12a of the lower die 12. The upper die 11 moves toward the lower die 12, such that the vertex of the protruding portion 11a moves along the center line in the cross-section of the cavity 12a, as shown in FIG. 4.

The lower die 12 is heated to 100 to 150° C., and the laminated product, in which the surface decorative material 4 and a plurality of the ligneous thin plates 9 are superimposed via the adhesive sheets 10, is put in the lower die 12. After the upper die 11 moves toward the lower die 12, such that the vertex of the protruding portion 11a moves along the center line in the cross-section of the cavity 12a, the laminated product is pressed for forming under conditions such that the die temperature is in a range of 120 to 180° C., the pressure is in a range of 0.1 to 4.0 MPa, and the pressing time is in a range of 2 to 5 minutes. Since the surface decorative material 4 and the ligneous thin plates 9 are laminated via the adhesive sheets 10, the strength of the surface material 3 is improved. Therefore, it is possible to form and integrate simultaneously the laminated product comprising the surface decorative material 4, the ligneous thin plates 9, and the adhesive sheets 10, without generating breaks such as cracks.

After a certain amount of time passes, the surface material 3 in which the surface decorative material 4 and a plurality of the ligneous thin plates 9 are adhered integrally via the adhesive sheets 10 and formed, is taken out from the forming die.

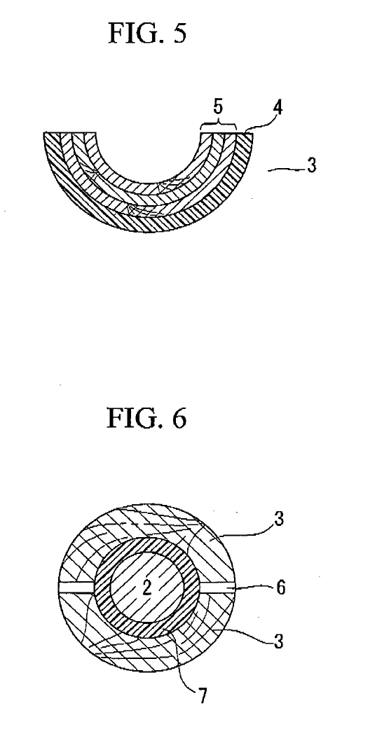

After removing unnecessary portions such as burrs, which are formed in the surface material 3 by the above process, in order to abutt and adhere the surface materials 3 and 3, the joining portions of the surface materials 3 and 3 are cut. Thereby, the surface material 3, which is shown in FIG. 5, is prepared. In FIG. 5, the joining portions of the surface materials 3 and 3 have flat surfaces. However, the joining portions of the surface materials 3 and 3 may have any surface such as a V-shape and an inverted V-shape, and curved shaped, as long as the surface materials 3 and 3 are reliably adhered.

Next, as shown in FIG. 6, the surface material 3 which is positioned at the front and the surface material 3 which is positioned at the back are abutted, so that the core 2 is positioned between these surface materials 3 and 3.

These surface materials 3 and 3 are adhered with an adhesive such as epoxy resins, and thereby seam portions 6 and 6 are generated. The surface material 3 and the core 2 are adhered with the adhesive layer 7, which is made of adhesive having high heat resistance such as epoxide resin adhesives, and foamed urethane resin adhesives. Here, since the adhesive sheet 10 is used for preparing the surface material 3, the strength of the surface material 3 is improved. Therefore, the adhesive layer 7 may be partially provided. Specifically, the adhesive layer 7 may be partially hollow.

Then, the seam portions 6 and 6 between the surface materials 3 and 3 are treated, for example, are filed with a sandpaper. Then, if necessary, the obtained product is colored. After that, the coating film 8 is provided on the product by coating polyester resin, and thereby the steering 1 is prepared.

The steering 1 of the present invention comprises the surface material 3 in which the surface decorative material 4 and a plurality of the ligneous thin plates 9 are laminated via the adhesive sheets 10 comprising nonwoven fabric in which an adhesive resin having high moisture resistance is permeated. Therefore, when the steering 1 is left in conditions such that the humidity is high, it is possible to prevent the moisture permeation in the ligneous thin plates 9, and thereby the generation of cracks at the joining portion 6 between the surface materials 3 and 3 is also prevented. In addition, since the adhesive sheet 10 comprising the nonwoven fabric is used for the steering 1, the thickness of the adhesive, which is suitable for improving the moisture resistance of the steering 1, is maintained. Furthermore, since the adhesive sheet 10 is positioned between the surface decorative material 4 and the ligneous thin plate 9 and between the ligneous thin plates 9 and 9, the strength of the surface material 3 is improved.

According to the production method of the present invention, a pre-forming process of the surface decorative material 4 is not necessary. That is, the surface material 3 is prepared by adhering integrally and forming the ligneous plywood layer 5 and the surface decorative material 4 in one process. Since the surface material 3 is made by laminating the surface decorative material 4 and a plurality of the ligneous thin plates 9 via the adhesive sheets 10, and the strength of the surface material 3 is improved by the adhesive sheets 10, breaks such as cracks are not substantially generated in the adhering and forming process. In addition, the adhesive sheet 10 comprising the nonwoven fabric, in which an adhesive resin is permeated, has extensibility. The extensibility contributes to the prevention of breakage during the adhering and forming process.

In the production method for a steering of the present invention, the adhering and forming for preparing the surface material 3 is carried out simultaneously. Compared with the conventional production method, in which a foam epoxy resin is used, it is possible to reduce the production time.

The steering and the production method of the steering of the present invention will be explained with reference to Examples and Comparative Examples.

### EXAMPLE 1

An adhesive sheet was prepared by permeating melarnine resin into a nonwoven fabric polyester having METSUKE of 60 g/m², which is the base material, so that an immersion amount of melamine resin is 60 g/m². Then, a plurality of the adhesive sheets, ligneous thin plates made of ayus, and surface decorated materials, which have a thickness of 0.2 mm and which are made of claro walnut, were stamped so as to have a fan shape shown in FIG. 3.

Three ligneous thin plates are laminated via the adhesive sheets, and thereby the ligneous plywood layer, was prepared. Then, the two surface decorated materials were attached on both sides of the ligneous plywood layer using tie adhesive sheets.

The prepared laminated product comprising the ligneous plywood layers and surface decorated materials, which were attached on both side of the ligneous plywood layers, was put in the forming die comprising an upper die and a lower die, which are shown in FIG. 4, was used. The lower die comprises a cavity having a shape which substantially conforms to the external shape of the steering. The upper die comprises a protruding portion on the lower surface thereof, which contacts the upper surface of the lower die. The protruding portion has a cross-section in a semi-circular shape which is smaller than the cross-section of the cavity of the lower die.

The prepared laminated product was put between the upper die and the lower die. The laminated product is pressed under conditions such that the die temperature is 150° C. the pressure is 1.0 MPa, and the pressing time is 5 minutes. Thereby a surface material for a steering, which has a substantial semicircular shape, was prepared.

After removing unnecessary portions such as burrs, which are formed in the surface material, in order to abutt and attach the surface materials, the joining portions of the surface materials are cut.

Two of the prepared surface materials were respectively positioned at the front and the back with respect to the core. Then, the surface material which is positioned at the front and the surface material which is positioned at the back were abutted, so that the core is positioned between these surface materials. These surface materials were attached with epoxy resin adhesive, and a steering preform was prepared. Then, the seam portions between the surface materials were filed with a sandpaper. The obtained product is coated with polyester, and the steering was prepared.

After that, the prepared surface material and the steering were evaluated as follows. The results are shown in the following Table 2.

Impact Resistance Ratio

Potential energy required to break the surface material for the steering was measured according to JIS K5600-5-3 (Falling-weight test). In Table 2, the relative value of potential energy in Examples and Comparative Examples is shown as impact resistance ratio in the case that the potential energy in Comparative Example 1 was assumed to “1”.

Cracking Resistant at Seam Portions

After the steering was left for 24 hours under conditions in that the equilibrium moisture content of ligneous material is 23%. After that, the existence of cracking at the seam portions is observed. In Table 2, X denotes that a cracking is observed, and O denotes that a cracking is not observed.

Thickness Swelling Ratio to Moisture

After measuring the thickness, the surface material was left for 24 hours under conditions in which the equilibrium moisture content of ligneous material was 23%. After that, the thickness of the surface material was measured. The thickness expansion ratio due to moisture was calculated from the thickness before and after testing.

Thickness Swelling Ratio to Water Absorption

According to JIS A 5908 5.8 (test of thickness expansion ratio to water absorption), after measuring the thickness, the surface material was put in water at 20° C. for 24 hours, and then the thickness of the surface material was measured. The thickness expansion ratio to water absorption was calculated from the thickness before and after testing.

### EXAMPLES 2 to 4

Surface materials and steerings were prepared in a manner identical to that of Example 1, except that the material of the surface decorated material. METSUKE of the nonwoven fabric polyester, which is the base material of the adhesive sheet, the permeation amount of adhesive resin, the number of the ligneous thin plate, and the number of the adhesive sheets were changed as in Table 1. The prepared surface materials and the steerings were evaluated, similarly to Example 1.

### COMPARATIVE EXAMPLE 1

A comparative surface material and a comparative steering were prepared in a manner identical to that of Example 1, except that a foamed epoxy resin was used, instead of the ligneous plywood layer comprising three ligneous thin plates made of ayus and two adhesive sheets. The prepared comparative surface material and the steering were evaluated similarly to Example 1. The results are shown in Table 2.

### COMPARATIVE EXAMPLE 2

A comparative surface material and a comparative steering were prepared in a manner identical to that of Example 1, except that a urea resin adhesive is coated by a roller instead of using the adhesive sheets The properties of the prepared comparative surface material and the steering were evaluated, similarly to Example 1. The results are shown in Table 2.

### COMPARATIVE EXAMPLE 3

A comparative surface material and a comparative steering were prepared in a manner identical to that of Example 1, except that the ligneous plywood layer comprising one ligneous thin plate made of ayus and two adhesive sheets was used instead of the ligneous plywood layer comprising three thin plate plates made of ayus and four adhesive sheets. The prepared comparative surface material and the steering were evaluated, similarly in Example 1. The results are shown in Table 2.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Material of Surface | claro walnut | maple | claro walnut | maple | claro walnut | claro walnut | claro walnut |
| decorated material | | | | | | | |
| Material of ligneous | ligneous thin | ligneous thin | ligneous thin | ligneous thin | *1 | ligneous thin | ligneous thin |
| plywood layer | plates made | plates made | plates made | plates made | | plates made of | plates made |
| | of ayus and | of ayus and | of ayus and | of ayus and | | ayus and an | of ayus and |
| | adhesive | adhesive | adhesive | adhesive | | adhesive | adhesive |
| | sheets | sheets | sheets | sheets | | | sheets |
| Thickness of ligneous | 1.7 | 1.9 | 2.7 | 3 | — | 1.4 | 0.6 |
| plywood layer (mm) | | | | | | | |
| Number of ligneous thin | 3 | 3 | 5 | 5 | — | 3 | 1 |
| plates | | | | | | | |
| Number of adhesive | 4 | 4 | 6 | 6 | — | — | 2 |
| sheets | | | | | | | |
| METSUKE of base | 60 | 100 | 60 | 100 | — | — | 60 |
| material of adhesive sheet | | | | | | | |
| (g/m²) | | | | | | | |
| Material of base material | nonwoven | nonwoven | nonwoven | nonwoven | — | — | nonwoven |
| | fabric | fabric | fabric | fabric | | | fabric |
| | polyester | polyester | polyester | polyester | | | polyester |
| Adhesive resin | melamine | melamine | melamine | melamine | — | urea resin | melamine |
| | resin | resin | resin | resin | | | resin |
| Immerse amount of | 60 | 100 | 60 | 100 | — | — | 60 |
| adhesive resin (g/m²) | | | | | | | |

*1 means that a foam epoxy resin is used instead of ligneous plywood layer.

TABLE 2

| | Example | Example | Example | Example | Comparative | Comparative | Comparative |
|---|---|---|---|---|---|---|---|
| | 1 | 2 | 3 | 4 | Example 1 | Example 2 | Example 3 |
| Impact resistance ratio | 10 | 10 | 10 | 10 | 1 | 8 | 2 |
| Cracking resistance at seam portions | ◯ | ◯ | ◯ | ◯ | ◯ | X | X |
| Thickness swelling ratio to moisture | 3 | 3 | 2 | 2 | — | 7 | 5 |
| (%) | | | | | | | |
| Thickness swelling ratio to water | 3 | 3 | 2 | 2 | — | 6 | 4 |
| absorption (%) | | | | | | | |

It is clear from Table 2 that the surface material and the steering, which comprises the ligneous plywood layer comprising three thin plate plates made of ayus and four adhesive sheets, or the ligneous plywood layer comprising five thin plate plates made of ayus and six adhesive sheets, has superior impact resistance to that of the surface material and the steering, which comprises the foam epoxy resin instead of the ligneous plywood layer.

Compared with the surface material and the steering, in which the urea resin adhesive was used to attach the ligneous thin plates, the surface material and the steering comprising the adhesive sheets has superior moisture resistance and impact resistance.

It is also clear that moisture resistance is improved by using plural ligneous thin plates and plural adhesive sheets. Thereby, it is possible to prevent the generation of cracks at the seam portions. In addition, impact resistance of the surface material and the steering was remarkably improved.

It is believed that by using the adhesive sheet, in which the adhesive resin was permeated in the base material, uniform moisture proofing over the entirety of the surface material due to the adhesive resin was obtained. In addition, it is believed that the base material of the adhesive sheet functions as a reinforcement material, and this improves the impact resistance. The moisture resistance and the impact resistance are further improved by laminating plural ligneous thin plates. Due to this, the generation of cracks at the seam portions of the steering is improved.

While preferred embodiments of the invention have been described and illustrated above, it should be understood that these arc exemplary of the invention and are not to be considered as limiting Additions, omissions, substitutions, and other modifications can be made without departing from the spirit or scope of the present invention.

For example, in Examples, the steering having a substantial semicircular shape was prepared using two surface materials having a semicircular shape. However, in the present invention, it is possible to prepare the steering having a circular shape using two surface materials having a circular shape. In addition, it is also possible to use three or more surface materials having a curved shape, in order to prepare the steering having a circular shape. Furthermore, in the Examples, two surface materials having a sane shape each other are used to prepare the steering. However, the present invention is not limited to this. For example, the surface material having an uneven surface, which is suitable for gripping and the surface material having a smooth surface may be combined to prepare the steering.

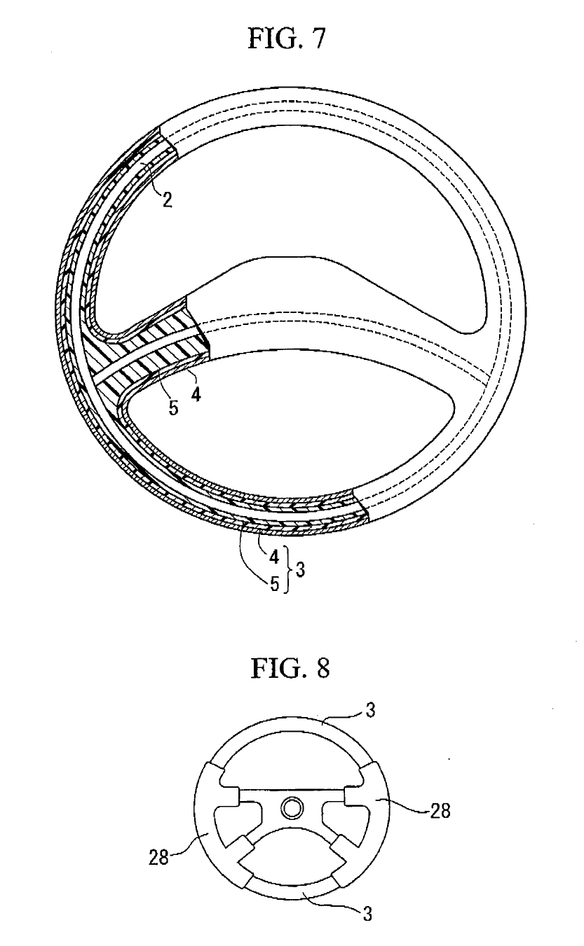

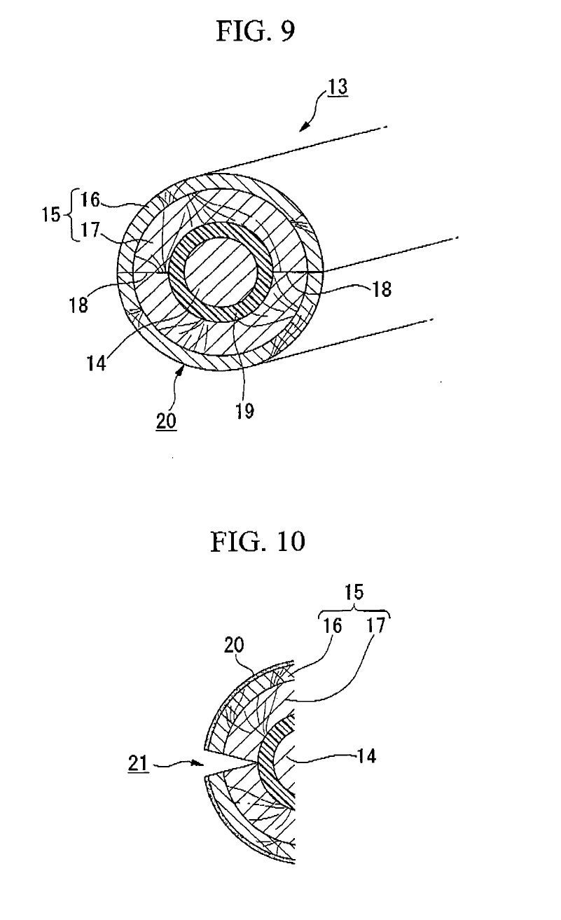

In addition, FIG. 7 shows one of examples of the steering for vehicle which can be produced by the present invention. The steering is produced by combining the surface materials 3 on the overall core 2, which has circular shape and comprises a bridge portion. FIG. 8 also shows the other examples of the steering for vehicle which can be produced by the present invention. The steering is produced by combining the surface materials 3 and leather covered portions 28 in which the core 2 is covered with soft resin and leather in that order.

Accordingly, the invention is not to be considered as limited by the foregoing description but is only limited by the scope of the appended claims.

1. A steering comprising a core and a surface material covering the core, the core and the surface material being integrally formed,
wherein the surface material comprises a surface decorative material, a plurality of ligneous thin plates, and adhesive sheets for adhering between the surface decorative material and the ligneous thin plate and between the ligneous thin plates; and
wherein the adhesive sheet comprises a base material in which an adhesive resin having a moisture resistance is permeated.

2. A steering according to claim 1, wherein the adhesive resin having a moisture resistance is at least one thermosetting resin selected from melamine resins, phenol resins, diallyl phthalate resins, epoxy resins, urea melamine resins, urea reins, and urea melamine phenol resins.

3. A production method for a steering comprising a core and a surface material covering the core, the core and the surface material being integrated, the method comprising the steps of,
laminating a surface decorative material and a plurality of ligneous thin plates via adhesive sheets in each of which an adhesive resin having a moisture resistance permeates in a base material; and
adhering and forming the surface decorative material and the plurality of ligneous thin plates in one process.
